(19) United States
(12) Patent Application Publication
(10) Pub. No.: US 2012/0147823 A1
(43) Pub. Date: Jun. 14, 2012

(54) METHODS AND APPARATUS FOR SCHEDULING OF PEER-TO-PEER COMMUNICATION IN A WIRELESS WIDE AREA NETWORK SPECTRUM

(75) Inventors: Shailesh Patil, Bridgewater, NJ (US); Hua Wang, Bridgewater, NJ (US); Xinzhou Wu, Monmouth Junction, NJ (US); Junyi Li, Chester, NJ (US)

(73) Assignee: QUALCOMM Incorporated, San Diego, CA (US)

(21) Appl. No.: 12/965,384

(22) Filed: Dec. 10, 2010

(51) Int. Cl. H04W 72/04

(52) U.S. Cl. 370/329

(57) ABSTRACT

A method of wireless communication includes determining peer-to-peer scheduling resources. The peer-to-peer scheduling resources are parallel in time to and multiplexed with non peer-to-peer resources. The peer-to-peer scheduling resources include a plurality of serial scheduling resource segments. Each of the serial scheduling resource segments provides contention resolution for a set of peer-to-peer links. In addition, the method includes communicating in one of the serial scheduling resource segments and/or the non peer-to-peer resources.

### BACKGROUND

1. Field

The present disclosure relates generally to communication systems, and more particularly, to scheduling of peer-to-peer communication in a wireless wide area network spectrum.

2. Background

In wireless wide area network (WWAN) communication, communication between wireless devices and a serving base station are through uplink (UL) and downlink (DL) channels. In order to reduce a load on the serving base station, two wireless devices in communication with each other through the serving base station may communicate directly using peer-to-peer communication rather than communicate through the serving base station. Time/frequency resources may be dedicated for each of WWAN and peer-to-peer communication. There is a need for improving the efficiency of concurrent WWAN and peer-to-peer communication in order to better utilize the available resources.

### SUMMARY

In an aspect of the disclosure, a method of wireless communication includes determining peer-to-peer scheduling resources. The peer-to-peer scheduling resources are parallel in time to and multiplexed with non peer-to-peer resources. The peer-to-peer scheduling resources include a plurality of serial scheduling resource segments. Each of the serial scheduling resource segments provides contention resolution for a set of peer-to-peer links. In addition, the method includes communicating in one of the serial scheduling resource segments and/or the non peer-to-peer resources.

In an aspect of the disclosure, a method of wireless communication includes determining a partitioning of peer-to-peer scheduling resources and non peer-to-peer resources parallel in time with the peer-to-peer scheduling resources. The peer-to-peer scheduling resources include a plurality of serial scheduling resource segments. The method includes communicating the partitioning of the peer-to-peer scheduling resources and the non peer-to-peer resources.

### BRIEF DESCRIPTION OF THE DRAWINGS

FIG. 1 is a diagram illustrating an example of a hardware implementation for an apparatus employing a processing system.

FIG. 2 is a drawing of a wireless peer-to-peer communications system.

FIG. 3 is a diagram illustrating a time structure for peer-to-peer communication between the wireless devices.

FIG. 4 is a diagram illustrating the channels in each frame of superframes in one grandframe.

FIG. 5 is a diagram illustrating an operation timeline of a traffic channel slot and a structure of connection scheduling.

FIG. 6A is a first diagram for illustrating a connection scheduling signaling scheme for the wireless devices.

FIG. 6B is a second diagram for illustrating a connection scheduling signaling scheme for the wireless devices.

FIG. 7 is a diagram illustrating resources split between WWAN and peer-to-peer resources.

FIG. 8 is a diagram illustrating an exemplary division of WWAN and peer-to-peer resources.

FIG. 9 is a diagram illustrating an exemplary structure of connection scheduling and parallel WWAN resources.

FIG. 10 is a flow chart of a method of wireless communication.

FIG. 11 is a flow chart of another method of wireless communication.

FIG. 12 is a conceptual block diagram illustrating the functionality of an exemplary apparatus.

FIG. 13 is a conceptual block diagram illustrating the functionality of another exemplary apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

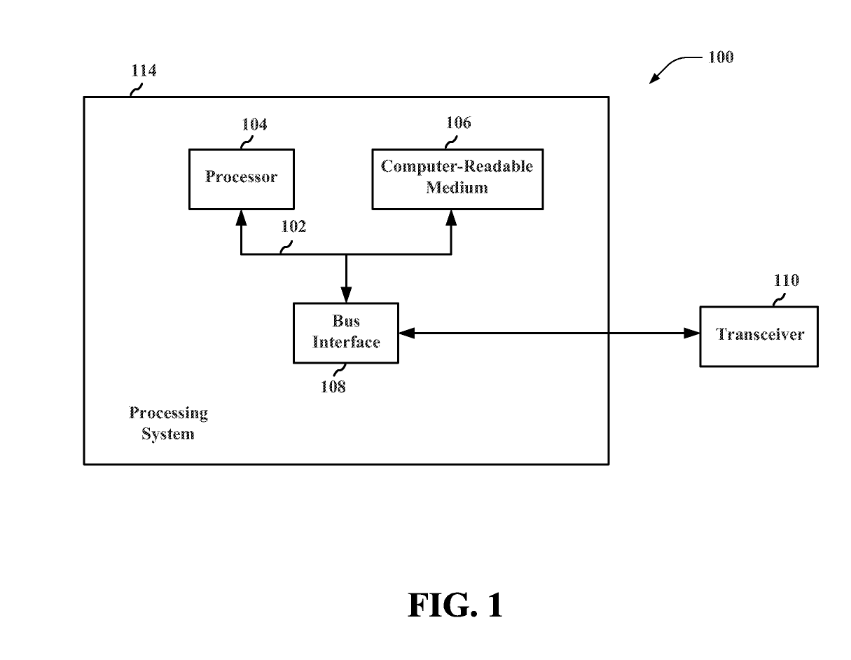

FIG. 1 is a conceptual diagram illustrating an example of a hardware implementation for an apparatus 100 employing a processing system 114. The processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatuses over a transmission medium.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

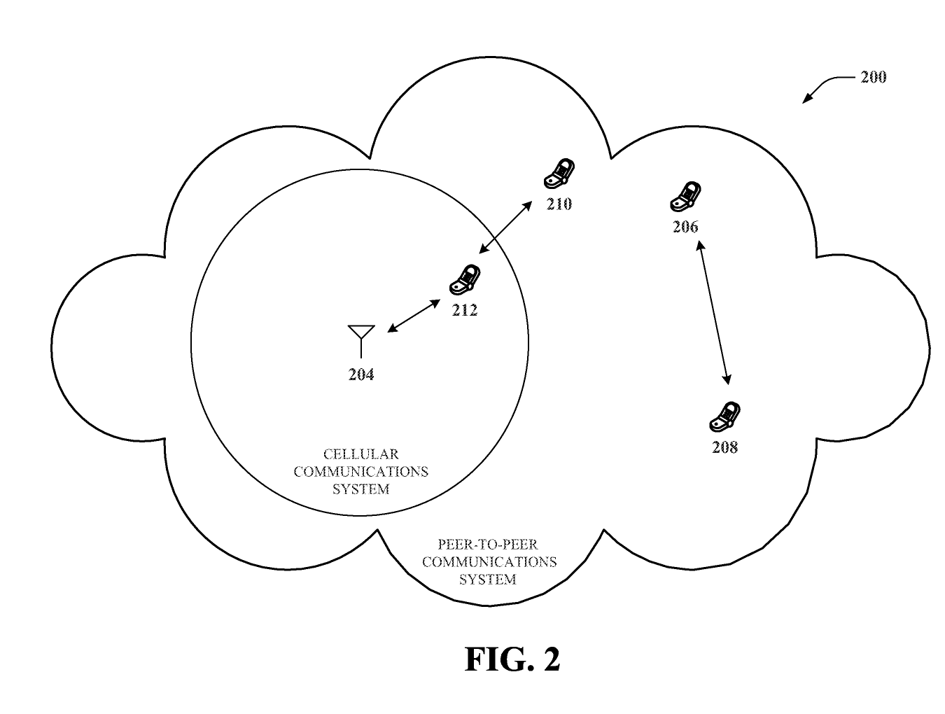

FIG. 2 is a drawing of an exemplary peer-to-peer communications system 200. The peer-to-peer communications system 200 includes a plurality of wireless devices 206, 208, 210, 212. The peer-to-peer communications system 200 may overlap with a cellular communications system, such as for example, a WWAN. Some of the wireless devices 206, 208, 210, 212 may communicate together in peer-to-peer communication, some may communicate with the base station 204, and some may do both. For example, as shown in FIG. 2, the wireless devices 206, 208 are in peer-to-peer communication and the wireless devices 210, 212 are in peer-to-peer communication. The wireless device 212 is also communicating with the base station 204.

The wireless device may alternatively be referred to by those skilled in the art as user equipment, a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless peer-to-peer communications systems, such as for example, a wireless peer-to-peer communication system based on FlashLinQ, WiMedia, Bluetooth, ZigBee, or Wi-Fi based on the IEEE 802.11 standard. To simplify the discussion, the exemplary methods and apparatus are discussed within the context of FlashLinQ. However, one of ordinary skill in the art would understand that the exemplary methods and apparatuses are applicable more generally to a variety of other wireless peer-to-peer communication systems.

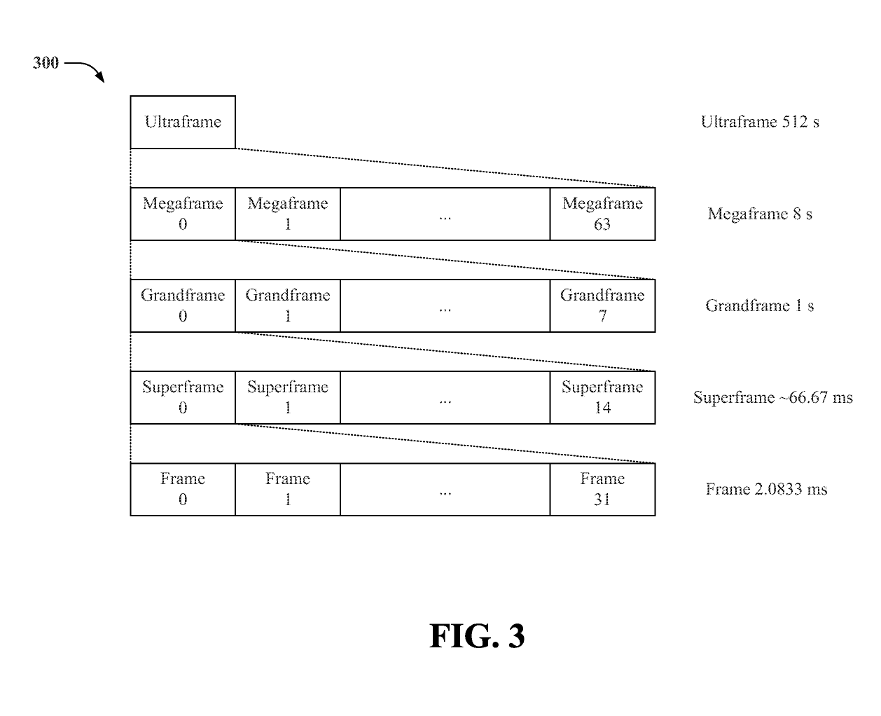

FIG. 3 is a diagram 300 illustrating a time structure for peer-to-peer communication between the wireless devices 100. An ultraframe is 512 seconds and includes 64 megaframes. Each megaframe is 8 seconds and includes 8 grandframes. Each grandframe is 1 second and includes 15 superframes. Each superframe is approximately 66.67 ms and includes 32 frames. Each frame is 2.0833 ms.

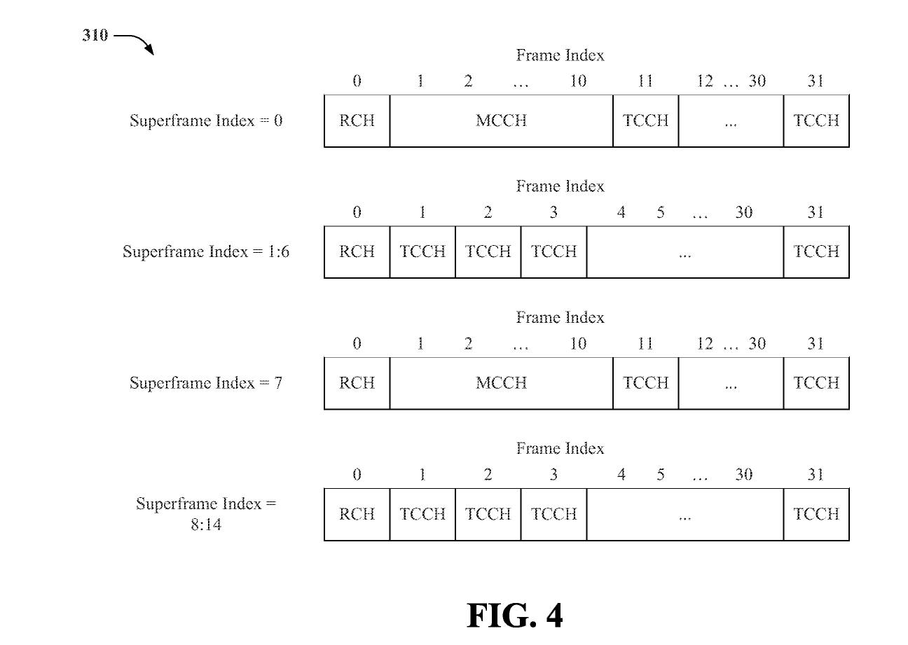

FIG. 4 is a diagram 310 illustrating the channels in each frame of superframes in one grandframe. In a first superframe (with index 0), frame 0 is a reserved channel (RCH), frames 1-10 are each a miscellaneous channel (MCCH), and frames 11-31 are each a traffic channel (TCCH). In the 2^{nd} through 7^{th} superframes (with index 1:6), frame 0 is a RCH and frames 1-31 are each a TCCH. In an 8^{th} superframe (with index 7), frame 0 is a RCH, frames 1-10 are each a MCCH, and frames 11-31 are each a TCCH. In the 9^{th} through 15^{th} superframes (with index 8:14), frame 0 is a RCH and frames 1-31 are each a TCCH. The MCCH of superframe index 0 includes a secondary timing synchronization channel, a peer discovery channel, a peer page channel, and a reserved slot. The MCCH of superframe index 7 includes a peer page channel and reserved slots. The TCCH includes connection scheduling, a pilot, channel quality indicator (CQI) feedback, a data segment, and an acknowledgement (ACK).

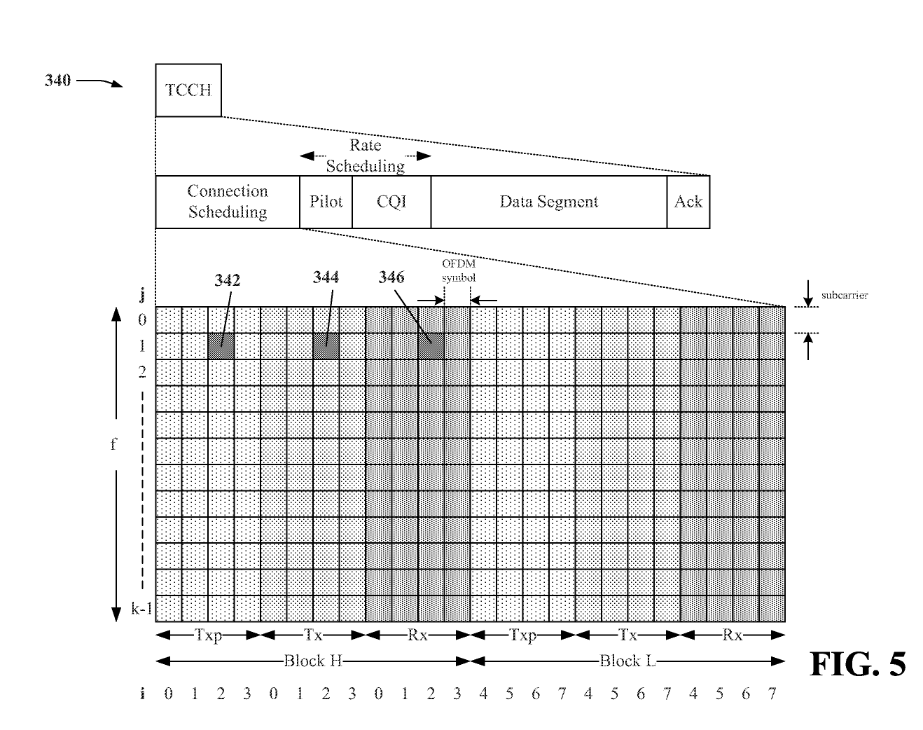

FIG. 5 is a diagram 340 illustrating an operation timeline of a TCCH slot and a structure of connection scheduling. As shown in FIG. 5, a TCCH slot includes four subchannels: connection scheduling, rate scheduling, data segment, and ACK. The rate scheduling subchannel includes a pilot segment and a CQI segment. The ACK subchannel is for transmitting an ACK or negative acknowledgement (NACK) in response to data received in the data segment subchannel. The connection scheduling subchannel includes two blocks, a higher priority Block H and a lower priority Block L. Each of Block H and Block L contains a plurality of resource elements, i.e., a plurality of subcarriers in the frequency domain and OFDM symbols in the time domain. Each of Block H and Block L spans the plurality of subcarriers and includes four OFDM symbols in a Txp-block, four OFDM symbols in a Tx-block, and four OFDM symbols in an Rx-block. One resource element (or tone) corresponds to one subcarrier and one OFDM symbol.

Each link has a CID. Based on the CID, for a particular TCCH slot, wireless devices in a link are allocated a resource element in the same respective OFDM symbol position in each of the Txp-block, the Tx-block, and the Rx-block at a particular subcarrier and within Block H or Block L. For example, in a particular TCCH slot, a link with CID=4 may be allocated the resource element 342 in the Txp-block of Block H, the resource element 344 in the Tx-block of Block H, and the resource element 346 in the Rx-block of Block H for transmitting/receiving a scheduling control signal. A transmit request signal in the Tx-block is transmitted with a power equal to a power for transmitting the data segment. A transmit request response signal in the Rx-block is transmitted with a power proportional to an inverse of the power of the received transmit request signal. The allocated trio of resource elements for the Txp-block, Tx-block, and Rx-block vary with respect to the subcarrier (e.g., k different subcarriers) and the respective OFDM symbol in each TCCH slot (e.g., 8 different OFDM symbols—4 in the Block H and 4 in the Block L).

The trio of resource elements allocated to a link dictates the medium access priority of the link. For example, the trio of resource elements 342, 344, 346 corresponds to i=2 and j=1. The medium access priority is equal to ki+j+1, where i is the respective OFDM symbol in each of the Txp, Tx, and Rx subblocks, j is the subcarrier, and k is the number of subcarriers. Accordingly, assuming k=28, the resource elements 342, 344, 346 correspond to a medium access priority of 58.

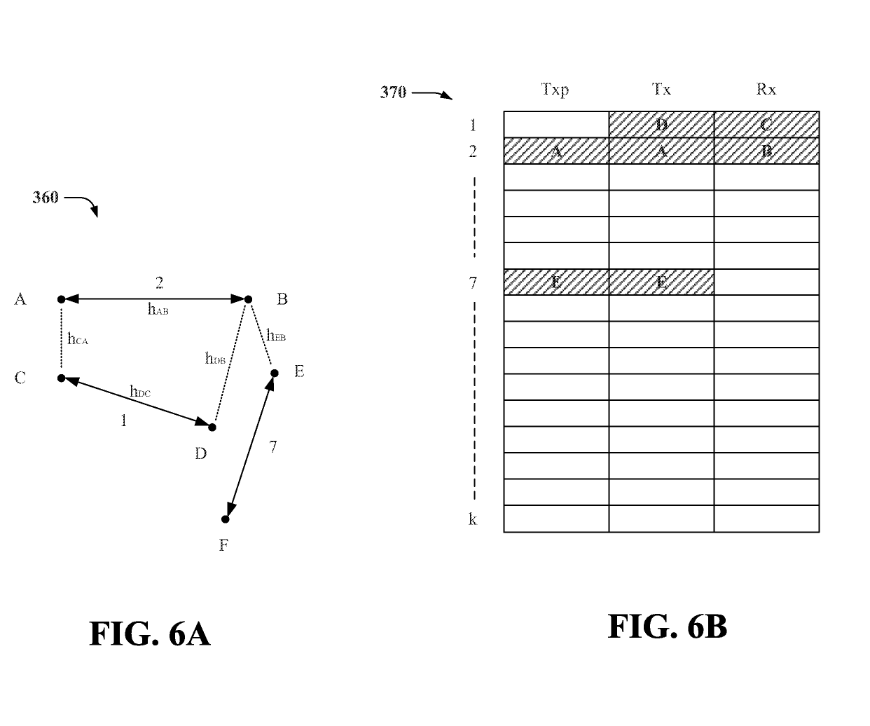

FIG. 6A is a first diagram 360 for illustrating an exemplary connection scheduling signaling scheme for the wireless devices 100. As shown in FIG. 6A, wireless device A is communicating with wireless device B, wireless device C is communicating with wireless device D, and wireless device E is communicating with wireless device F. The wireless device A is assumed to have transmit priority over the wireless device B, the wireless device C is assumed to have transmit priority over the wireless device D, and the wireless device E is assumed to have transmit priority over the wireless device F. Each of the links has a different medium access priority depending on the particular slot for communication. For the particular slot for communication, link 1 (A, B) is assumed to have a medium access priority of 2, link 2 (C, D) is assumed to have a medium access priority of 1, and link 3 (E, F) is assumed to have a medium access priority of 7.

FIG. 6B is a second diagram 370 for illustrating an exemplary connection scheduling signaling scheme for the wireless devices 100. FIG. 6B shows connection scheduling resources of first respective OFDM symbols (i=0, see FIG. 5) of Txp, Tx, and Rx subblocks in Block H (corresponding to medium access priorities 1 through k) in the connection scheduling subchannel. The connection scheduling resources include a plurality of subcarriers, each of the subcarriers corresponding to one of k frequency bands. Each of the frequency bands corresponds to a particular medium access priority. One block in the connection scheduling resources is split into three subblocks/phases: Txp, Tx, and Rx. The Txp-block is used by the node with transmit priority in the link to indicate whether the node with transmit priority will act as a transmitter or a receiver. If the node with transmit priority transmits on the allocated OFDM symbol in the Txp-block, the node with transmit priority indicates to the node without transmit priority an intent to act as a transmitter. If the node with transmit priority does not transmit on the allocated OFDM symbol in the Txp-block, the node with transmit priority indicates to the node without transmit priority an intent to act as a receiver. The Tx-block is used by potential transmitters to make a request to be scheduled. The transmitter transmits a direct power signal on the allocated OFDM symbol in the Tx-block at a power equal to a power used for the traffic channel (i.e., a power for transmitting the data segment). Each potential receiver listens to the tones in the Tx-blocks, compares the received power on each of the Tx-blocks to the received power on the Tx-block allocated to the transmitter of its own link, and determines whether to Rx-yield based on its own link medium access priority relative to other link medium access priorities and the comparison.

For example, assume the nodes A, D, and E transmit a transmit request signal in the Tx-block at a power equal to P_{A}, P_{D}, and P_{E}, respectively. The node B receives the transmit request signal from the node A at a power equal to P_{A}|h_{AB}|², where h_{AB} is the pathloss between the node A and the node B. The node B receives the transmit request signal from the node D with a power equal to P_{D}|h_{DB}|², where h_{DB} is the pathloss between the node D and the node B. The node B receives the transmit request signal from the node E with a power equal to P_{E}|h_{EB}|², where h_{EB} is the pathloss between the node E and the node B. The node B compares the power of the received transmit request signal from the node A divided by the sum of the powers of the received transmit request signals from other nodes with a higher priority to a threshold in order to determine whether to Rx-yield. The node B does not Rx-yield if the node B expects a reasonable signal to interference ratio (SIR) if scheduled. That is, the node B Rx-yields unless P_{A}|h_{AB}|²/P_{D}|h_{DB}|²>γ_{RX}, where γ_{Rx} is the threshold (e.g., 9 dB).

The Rx-block is used by the potential receivers. If the receiver chooses to Rx-yield, the receiver does not transmit in the allocated OFDM symbol in the Rx-block; otherwise, the receiver transmits an inverse echo power signal in the allocated OFDM symbol in the Rx-block at a power proportional to an inverse of the power of the received direct power signal from the transmitter of its own link. All of the transmitters listen to the tones in the Rx-block to determine whether to Tx-yield transmission of the data segment.

For example, the node C, having received the transmit request signal from the node D at a power equal to P_{D}|h_{DC}|², transmits a transmit request response signal in the Rx-block at a power equal to K/P_{D}|h_{DC}|², where h_{DC} is the pathloss between the node D and the node C, and K is a constant known to all nodes. The node A receives the transmit request response signal from the node C at a power equal to K|h_{CA}|²|P_{D}|h_{DC}|², where h_{CA} is the pathloss between the node C and the node A. The node A Tx-yields if the node A would cause too much interference to the node C. That is, the node A Tx-yields unless P_{D}|h_{DC}|²/P_{A}|h_{CA}|²>γ_{TX} where γ_{TX} is a threshold (e.g., 9 dB).

The connection scheduling signaling scheme is best described in conjunction with an example. The node C has no data to transmit and does not transmit in the Txp-block for medium access priority 1, the node A has data to transmit and transmits in the Txp-block for medium access priority 2, and the node E has data to transmit and transmits in the Txp-block for medium access priority 7. The node D has data to transmit and transmits in the Tx-block for medium access priority 1, the node A transmits in the Tx-block for medium access priority 2, and the node E transmits in the Tx-block for medium access priority 7. The node C listens to the tones in the Tx-blocks and determines to transmit in the Rx-block for medium access priority 1, as the node C has the highest priority. The node B listens to the tones in the Tx-blocks, determines that its link would not interfere with link 2, which has a higher medium access priority, and transmits in the Rx-block for medium access priority 2. The node F listens to the tones in the Tx-blocks, determines that its link would interfere with link 1 and/or link 2, both of which have a higher medium access priority, and Rx-yields by not transmitting in the Rx-block for medium access priority 7. Subsequently, both D and A listen to the tones in the Rx blocks to determine whether to transmit the data. Because D has a higher link medium access priority than A, D transmits its data. A will Tx-yield transmission of the data if A determines that its transmission would interfere with the transmission from D.

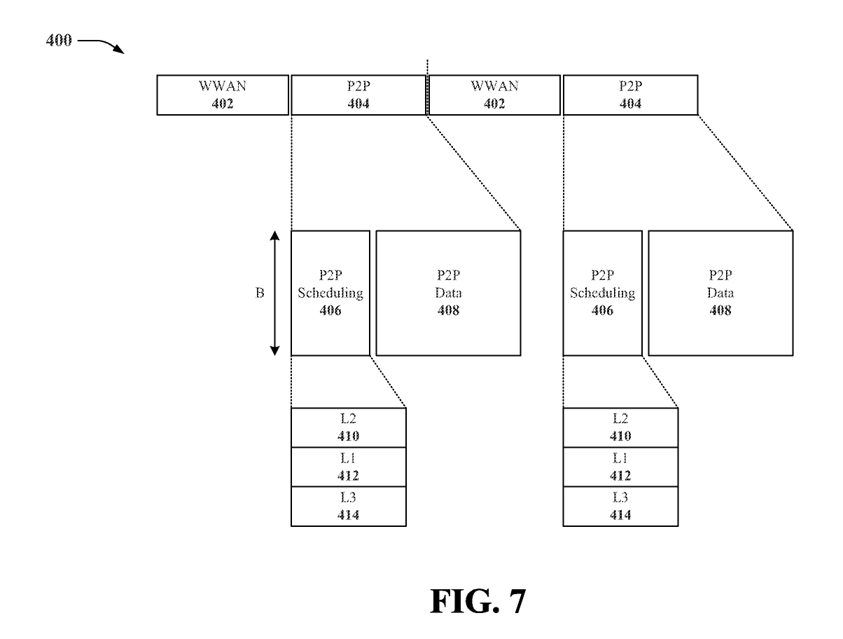

FIG. 7 is a diagram 400 illustrating resources split between WWAN and peer-to-peer resources. Scheduling of peer-to-peer communication can be complicated because a reasonable scheduling algorithm would need to take into account multiple factors such as the links that want to be scheduled, which wireless device in a particular link is the data source and which is the data destination, the direct link signal strength between the source and the destination on a peer-to-peer link, the amount of interference a peer-to-peer link can cause to another peer-to-peer link, the amount of interference that a peer-to-peer link will experience when it is scheduled, and the relative priorities of links that want to be scheduled.

Many of these factors are localized. To enable peer-to-peer traffic in WWAN, the cost of periodically feeding back all the above factors to the base station can be prohibitively large. As such, an efficient use of resources is to allow links to make scheduling decisions while the base station applies centralized control at a slower time scale. As shown in FIG. 7, peer-to-peer communication in a WWAN may be enabled by periodically allocating peer-to-peer resources 404 that are orthogonal to the WWAN resources 402. The peer-to-peer resources 404 may include peer-to-peer scheduling resources 406 used for distributed scheduling and peer-to-peer data traffic resources 408 (e.g., connection scheduling resources and data segment resources as discussed supra with respect to FIG. 5).

As discussed supra in relation to FIG. 5, the peer-to-peer scheduling resources 406 may include a higher priority block (i.e., Block H) of peer-to-peer scheduling resources and a lower priority block (i.e., Block L) of peer-to-peer resources. The peer-to-peer scheduling resources 406 may utilize the entire allotted bandwidth B. Referring again to FIG. 6A, assume link 2 (C, D) in resource segment 410, link 1 (A, B) in resource segment 412, and link 3 (E, F) in resource segment 414 are allotted the same priority block (i.e., Block H or Block L). In that case, links 2, 1, and 3 may encounter the cascade yielding problem in which link 1 yields to the higher priority link 2 as a result of a contention transmission from link 2 and link 3 yields to the higher priority link 1 as a result of the contention transmission from link 1, even though link 2 and link 3 may be able to be scheduled for a data transmission at the same time without causing too much interference to each other. As such, cascade yielding can cause scheduling inefficiencies.

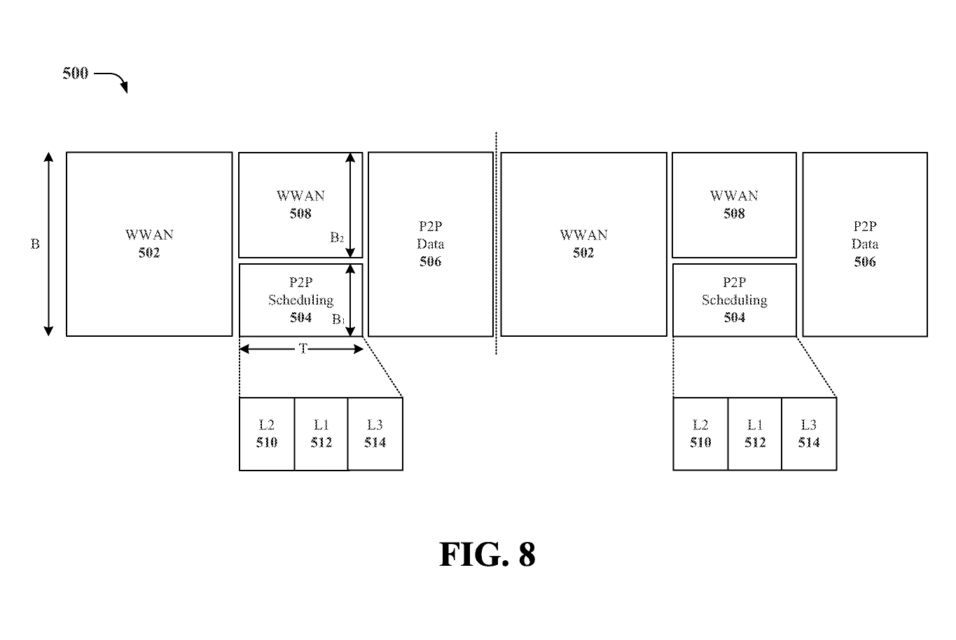

FIG. 8 is a diagram 500 illustrating an exemplary division of WWAN and peer-to-peer resources. As shown in FIG. 8, peer-to-peer communication in a WWAN may be enabled by periodically allocating peer-to-peer resources 504, 506 that are orthogonal to the WWAN resources 502, 508. The peer-to-peer resources 504, 506 include peer-to-peer scheduling resources 504 used for distributed scheduling and peer-to-peer data resources 506. The peer-to-peer scheduling resources 504 have a bandwidth B₁ that is less than the bandwidth B. The remaining bandwidth B₂ is used for WWAN resources 508, which are parallel in time to and multiplexed with the peer-to-peer scheduling resources 504. In relation to FIG. 7, the peer-to-peer scheduling resources 504 have a bandwidth B₁ that is less than the bandwidth B of the peer-to-peer scheduling resources 406, but the time period T of the peer-to-peer scheduling resources 504 is greater than the time period of the peer-to-peer scheduling resources 406. As such, resources of the peer-to-peer scheduling resources 406 have been shifted so that the peer-to-peer scheduling resources 504 have less resources in parallel and more resources in series. Having more resources in series allows for a greater likelihood that a set of three or more links can avoid the cascade yielding problem, as the set of links have a greater likelihood of being scheduled at different time periods within the peer-to-peer scheduling resources 504 than otherwise.

For example, as shown in FIG. 8, assume link 2 in resource segment 510, link 1 in resource segment 512, and link 3 in resource segment 514 perform connection scheduling at different time periods. Link 2 is first, as link 2 has the highest priority, following by link 1, and then link 3, which has the lowest priority. Assume link 1 yields to link 2 as a result of the contention transmission from link 2. Because link 1 yields, link 1 does not broadcast a contention transmission. As such, link 3 will not receive the contention transmission from link 1 and therefore will not yield to link 1. If link 3 determines not to yield to link 2 as a result of the contention transmission from link 2, both link 2 and link 3 may be scheduled for a data transmission at the same time. As such, the links 2, 1, and 3 avoid the cascade yielding problem. By providing for a greater amount of scheduling resources in series, sets of links have a greater likelihood of being scheduled in serial scheduling resource segments (e.g., 510, 512, 514), and therefore the likelihood of cascade yielding is reduced. The parallel resources 508 not utilized may be utilized for non peer-to-peer communications, such as WWAN communications. The non peer-to-peer resources 508 for the non peer-to-peer communications are parallel in time to and multiplexed with the peer-to-peer scheduling resources 504.

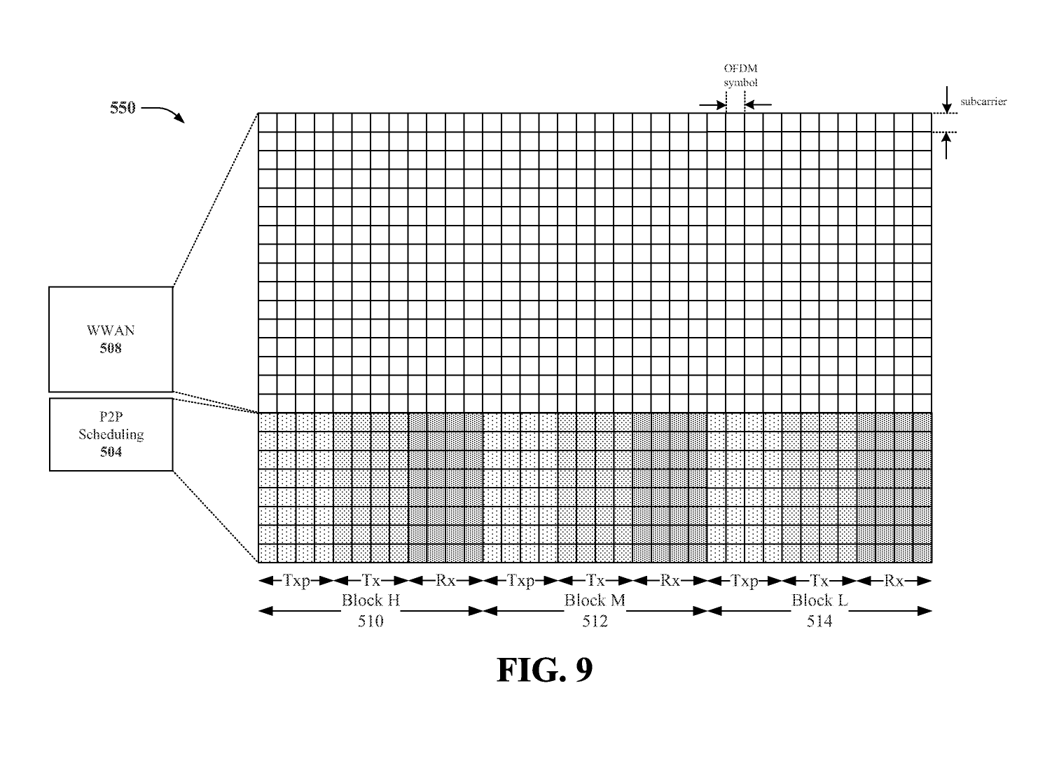

FIG. 9 is a diagram 550 illustrating an exemplary structure of connection scheduling and parallel WWAN resources within FlashLinQ. However, as discussed supra, the exemplary methods and apparatuses are applicable to any of a variety of wireless peer-to-peer communications systems, with FlashLinQ being just one peer-to-peer communication system to which the exemplary methods and apparatuses are applicable. As shown in FIG. 9, the WWAN resources 508 and the peer-to-peer scheduling resources 504 are in parallel. Each of the WWAN resources 508 and peer-to-peer scheduling resources 504 are split into a plurality of OFDM symbols, each with a plurality of subcarriers. The peer-to-peer scheduling resources 504 may be split into a plurality of blocks, such as a high priority block 510, a medium priority block 512, and a low priority block 514. Each of the blocks may provide a Txp-block, a Tx-block, and an Rx-block for allowing links to perform connection scheduling.

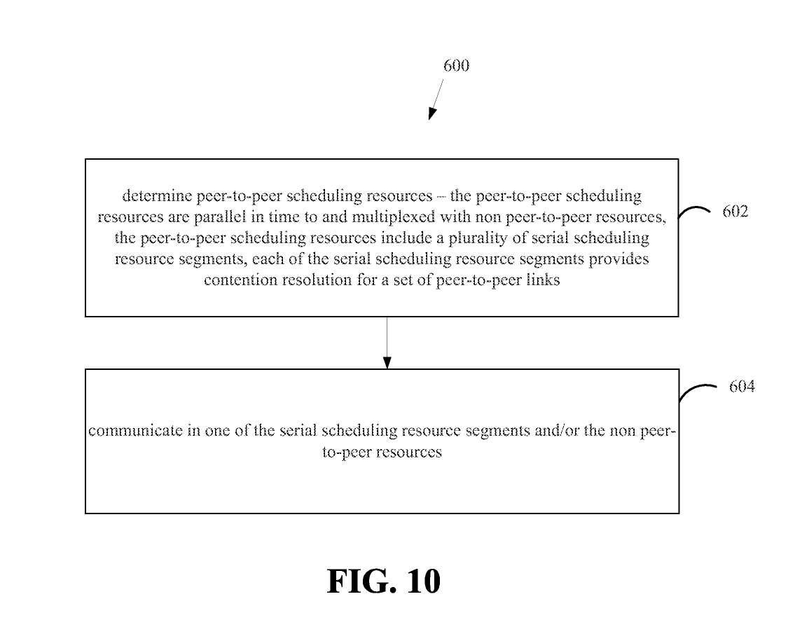

FIG. 10 is a flow chart 600 of an exemplary method. The method is performed by a wireless device. As shown in FIG. 10, the wireless device determines peer-to-peer scheduling resources 504 (602). The peer-to-peer scheduling resources 504 are parallel in time to and multiplexed with non peer-to-peer resources 508 (602). The peer-to-peer scheduling resources 504 include a plurality of serial scheduling resource segments (e.g., 510, 512, 514) (602). Each of the serial scheduling resource segments provides contention resolution for a set of peer-to-peer links (602). In addition, the wireless device communicates in one of the serial scheduling resource segments and/or the non peer-to-peer resources 508 (604). The non peer-to-peer resources 508 may be WWAN resources. In one configuration, the peer-to-peer scheduling resources 504 are for scheduling a data transmission in peer-to-peer data resources 506 and a peer-to-peer scheduling resources bandwidth B₁ of the peer-to-peer scheduling resources 504 is less than a peer-to-peer data resources bandwidth B of the peer-to-peer data resources 506. In one configuration, the peer-to-peer data resources bandwidth B is approximately equal to the peer-to-peer scheduling resources bandwidth B₁ and a bandwidth B₂ of the non peer-to-peer resources 508. In one configuration, the plurality of serial scheduling resource segments include at least three serial scheduling segments.

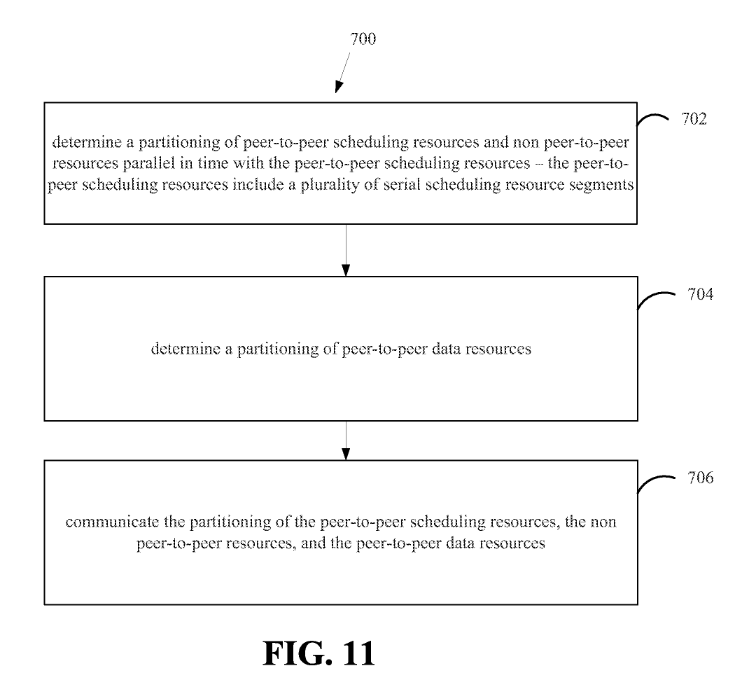

FIG. 11 is a flow chart 700 of an exemplary method. The method is performed by a base station. As shown in FIG. 11, the base station determines a partitioning in time and frequency of peer-to-peer scheduling resources 504 and non peer-to-peer resources 508 parallel in time with the peer-to-peer scheduling resources 504 (702). The peer-to-peer scheduling resources 504 include a plurality of serial scheduling resource segments (e.g., 510, 512, 514) (702). In addition, the base station may determine a partitioning of peer-to-peer data resources 506 (704). Furthermore, the base station communicates the partitioning of the peer-to-peer scheduling resources 504, the non peer-to-peer resources 508, and the peer-to-peer data resources 506 (706). The partitioning may be periodic. The non peer-to-peer resources 508 may be WWAN resources. In one configuration, the peer-to-peer scheduling resources 504 are for scheduling a data transmission in the peer-to-peer data resources 506 and a peer-to-peer scheduling resources bandwidth B₁ of the peer-to-peer scheduling resources 504 is less than a peer-to-peer data resources bandwidth B of the peer-to-peer data resources 506. In one configuration, the peer-to-peer data resources bandwidth B is approximately equal to the peer-to-peer scheduling resources bandwidth B₁ and a bandwidth of the non peer-to-peer resources B₂. In one configuration, the plurality of serial scheduling resource segments include at least three serial scheduling segments.

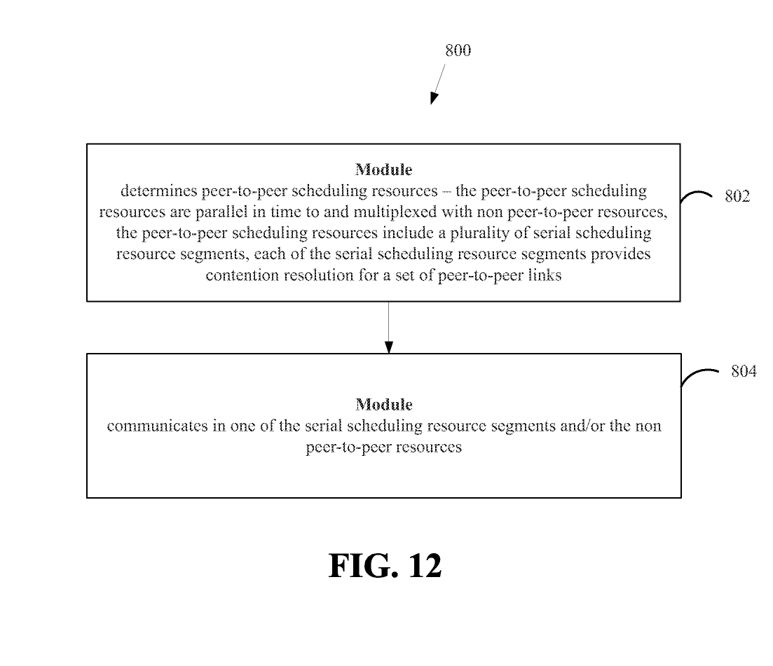

FIG. 12 is a conceptual block diagram 800 illustrating the functionality of an exemplary apparatus 100. The apparatus 100 includes a module 802 that determines peer-to-peer scheduling resources. The peer-to-peer scheduling resources are parallel in time to and multiplexed with non peer-to-peer resources. The peer-to-peer scheduling resources include a plurality of serial scheduling resource segments. Each of the serial scheduling resource segments provides contention resolution for a set of peer-to-peer links. In addition, the apparatus 100 includes a module 804 that communicates in one of the serial scheduling resource segments and/or the non peer-to-peer resources.

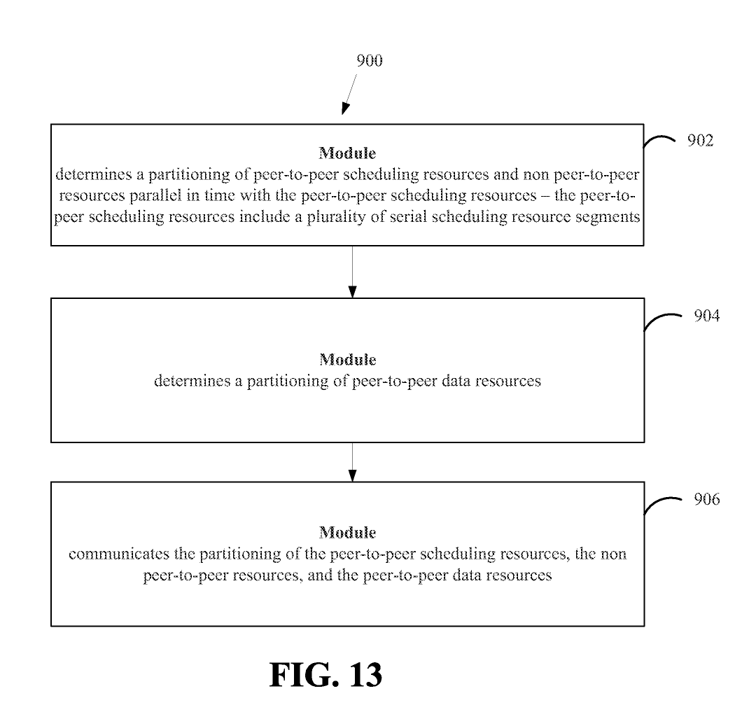

FIG. 13 is a conceptual block diagram 900 illustrating the functionality of an exemplary apparatus 100. The apparatus 100 includes a module 902 that determines a partitioning in time and frequency of peer-to-peer scheduling resources and non peer-to-peer resources parallel in time with the peer-to-peer scheduling resources. The peer-to-peer scheduling resources include a plurality of serial scheduling resource segments. In addition, the apparatus 100 may include a module 904 that determines a partitioning of peer-to-peer data resources. Furthermore, the apparatus 100 may further include a module 906 that communicates the partitioning of the peer-to-peer scheduling resources, the non peer-to-peer resources, and the peer-to-peer data resources.

Referring to FIG. 1, in one configuration, the apparatus 100, which may be a wireless device, includes means for determining peer-to-peer scheduling resources. The peer-to-peer scheduling resources are parallel in time to and multiplexed with non peer-to-peer resources. The peer-to-peer scheduling resources include a plurality of serial scheduling resource segments. Each of the serial scheduling resource segments provides contention resolution for a set of peer-to-peer links. In addition, the apparatus 100 includes means for communicating in one of the serial scheduling resource segments and/or the non peer-to-peer resources. The aforementioned means is the processing system 114 configured to perform the functions recited by the aforementioned means.

In one configuration, the apparatus 100, which may be a base station, includes means for determining a partitioning of peer-to-peer scheduling resources and non peer-to-peer resources parallel in time with the peer-to-peer scheduling resources. The peer-to-peer scheduling resources include a plurality of serial scheduling resource segments. In addition, the apparatus 100 includes means for communicating the partitioning of the peer-to-peer scheduling resources and the non peer-to-peer resources. The apparatus 100 may further include means for determining a partitioning of peer-to-peer data resources and means for communicating the partitioning of the peer-to-peer data resources. The aforementioned means is the processing system 114 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining peer-to-peer scheduling resources, the peer-to-peer scheduling resources being parallel in time to and multiplexed with non peer-to-peer resources, the peer-to-peer scheduling resources including a plurality of serial scheduling resource segments, each of the serial scheduling resource segments providing contention resolution for a set of peer-to-peer links; and
communicating in one of the serial scheduling resource segments and/or the non peer-to-peer resources.

2. The method of claim 1, wherein the non peer-to-peer resources are wireless wide area network (WWAN) resources.

3. The method of claim 1, wherein the peer-to-peer scheduling resources are for scheduling a data transmission in peer-to-peer data resources and a peer-to-peer scheduling resources bandwidth of the peer-to-peer scheduling resources is less than a peer-to-peer data resources bandwidth of the peer-to-peer data resources.

4. The method of claim 3, wherein the peer-to-peer data resources bandwidth is approximately equal to the peer-to-peer scheduling resources bandwidth and a bandwidth of the non peer-to-peer resources.

5. The method of claim 1, wherein the plurality of serial scheduling resource segments comprise at least three serial scheduling segments.

6. A method of wireless communication, comprising:
determining a partitioning of peer-to-peer scheduling resources and non peer-to-peer resources parallel in time with the peer-to-peer scheduling resources, the peer-to-peer scheduling resources including a plurality of serial scheduling resource segments; and
communicating the partitioning of the peer-to-peer scheduling resources and the non peer-to-peer resources.

7. The method of claim 6, wherein the partitioning is periodic.

8. The method of claim 6, wherein the non peer-to-peer resources are wireless wide area network (WWAN) resources.

9. The method of claim 6, further comprising:
determining a partitioning of peer-to-peer data resources; and
communicating the partitioning of the peer-to-peer data resources.

10. The method of claim 9, wherein the peer-to-peer scheduling resources are for scheduling a data transmission in the peer-to-peer data resources and a peer-to-peer scheduling resources bandwidth of the peer-to-peer scheduling resources is less than a peer-to-peer data resources bandwidth of the peer-to-peer data resources.

11. The method of claim 10, wherein the peer-to-peer data resources bandwidth is approximately equal to the peer-to-peer scheduling resources bandwidth and a bandwidth of the non peer-to-peer resources.

12. The method of claim 6, wherein the plurality of serial scheduling resource segments comprise at least three serial scheduling segments.

13. An apparatus for wireless communication, comprising:
means for determining peer-to-peer scheduling resources, the peer-to-peer scheduling resources being parallel in time to and multiplexed with non peer-to-peer resources, the peer-to-peer scheduling resources including a plurality of serial scheduling resource segments, each of the serial scheduling resource segments providing contention resolution for a set of peer-to-peer links; and
means for communicating in one of the serial scheduling resource segments and/or the non peer-to-peer resources.

14. The apparatus of claim 13, wherein the non peer-to-peer resources are wireless wide area network (WWAN) resources.

15. The apparatus of claim 13, wherein the peer-to-peer scheduling resources are for scheduling a data transmission in peer-to-peer data resources and a peer-to-peer scheduling resources bandwidth of the peer-to-peer scheduling resources is less than a peer-to-peer data resources bandwidth of the peer-to-peer data resources.

16. The apparatus of claim 15, wherein the peer-to-peer data resources bandwidth is approximately equal to the peer-to-peer scheduling resources bandwidth and a bandwidth of the non peer-to-peer resources.

17. The apparatus of claim 13, wherein the plurality of serial scheduling resource segments comprise at least three serial scheduling segments.

18. An apparatus for wireless communication, comprising:
means for determining a partitioning of peer-to-peer scheduling resources and non peer-to-peer resources parallel in time with the peer-to-peer scheduling resources, the peer-to-peer scheduling resources including a plurality of serial scheduling resource segments; and
means for communicating the partitioning of the peer-to-peer scheduling resources and the non peer-to-peer resources.

19. The apparatus of claim 18, wherein the partitioning is periodic.

20. The apparatus of claim 18, wherein the non peer-to-peer resources are wireless wide area network (WWAN) resources.

21. The apparatus of claim 18, further comprising:
means for determining a partitioning of peer-to-peer data resources; and
means for communicating the partitioning of the peer-to-peer data resources.

22. The apparatus of claim 21, wherein the peer-to-peer scheduling resources are for scheduling a data transmission in the peer-to-peer data resources and a peer-to-peer scheduling resources bandwidth of the peer-to-peer scheduling resources is less than a peer-to-peer data resources bandwidth of the peer-to-peer data resources.

23. The apparatus of claim 22, wherein the peer-to-peer data resources bandwidth is approximately equal to the peer-to-peer scheduling resources bandwidth and a bandwidth of the non peer-to-peer resources.

24. The apparatus of claim 18, wherein the plurality of serial scheduling resource segments comprise at least three serial scheduling segments.

25. A computer program product for wireless communication, comprising:
a computer-readable medium comprising code for:
determining peer-to-peer scheduling resources, the peer-to-peer scheduling resources being parallel in time to and multiplexed with non peer-to-peer resources, the peer-to-peer scheduling resources including a plurality of serial scheduling resource segments, each of the serial scheduling resource segments providing contention resolution for a set of peer-to-peer links; and
communicating in one of the serial scheduling resource segments and/or the non peer-to-peer resources.

26. The computer program product of claim 25, wherein the non peer-to-peer resources are wireless wide area network (WWAN) resources.

27. The computer program product of claim 25, wherein the peer-to-peer scheduling resources are for scheduling a data transmission in peer-to-peer data resources and a peer-to-peer scheduling resources bandwidth of the peer-to-peer scheduling resources is less than a peer-to-peer data resources bandwidth of the peer-to-peer data resources.

28. The computer program product of claim 27, wherein the peer-to-peer data resources bandwidth is approximately equal to the peer-to-peer scheduling resources bandwidth and a bandwidth of the non peer-to-peer resources.

29. The computer program product of claim 25, wherein the plurality of serial scheduling resource segments comprise at least three serial scheduling segments.

30. A computer program product for wireless communication, comprising:
a computer-readable medium comprising code for:
determining a partitioning of peer-to-peer scheduling resources and non peer-to-peer resources parallel in time with the peer-to-peer scheduling resources, the peer-to-peer scheduling resources including a plurality of serial scheduling resource segments; and
communicating the partitioning of the peer-to-peer scheduling resources and the non peer-to-peer resources.

31. The computer program product of claim 30, wherein the partitioning is periodic.

32. The computer program product of claim 30, wherein the non peer-to-peer resources are wireless wide area network (WWAN) resources.

33. The computer program product of claim 30, wherein the computer-readable medium further comprises code for:
determining a partitioning of peer-to-peer data resources; and
communicating the partitioning of the peer-to-peer data resources.

34. The computer program product of claim 33, wherein the peer-to-peer scheduling resources are for scheduling a data transmission in the peer-to-peer data resources and a peer-to-peer scheduling resources bandwidth of the peer-to-peer scheduling resources is less than a peer-to-peer data resources bandwidth of the peer-to-peer data resources.

35. The computer program product of claim 34, wherein the peer-to-peer data resources bandwidth is approximately equal to the peer-to-peer scheduling resources bandwidth and a bandwidth of the non peer-to-peer resources.

36. The computer program product of claim 30, wherein the plurality of serial scheduling resource segments comprise at least three serial scheduling segments.

37. An apparatus for wireless communication, comprising:
a processing system configured to:
determine peer-to-peer scheduling resources, the peer-to-peer scheduling resources being parallel in time to and multiplexed with non peer-to-peer resources, the peer-to-peer scheduling resources including a plurality of serial scheduling resource segments, each of the serial scheduling resource segments providing contention resolution for a set of peer-to-peer links; and
communicate in one of the serial scheduling resource segments and/or the non peer-to-peer resources.

38. The apparatus of claim 37, wherein the non peer-to-peer resources are wireless wide area network (WWAN) resources.

39. The apparatus of claim 37, wherein the peer-to-peer scheduling resources are for scheduling a data transmission in peer-to-peer data resources and a peer-to-peer scheduling resources bandwidth of the peer-to-peer scheduling resources is less than a peer-to-peer data resources bandwidth of the peer-to-peer data resources.

40. The apparatus of claim 39, wherein the peer-to-peer data resources bandwidth is approximately equal to the peer-to-peer scheduling resources bandwidth and a bandwidth of the non peer-to-peer resources.

41. The apparatus of claim 37, wherein the plurality of serial scheduling resource segments comprise at least three serial scheduling segments.

42. An apparatus for wireless communication, comprising:
a processing system configured to:
determine a partitioning of peer-to-peer scheduling resources and non peer-to-peer resources parallel in time with the peer-to-peer scheduling resources, the peer-to-peer scheduling resources including a plurality of serial scheduling resource segments; and
communicate the partitioning of the peer-to-peer scheduling resources and the non peer-to-peer resources.

43. The apparatus of claim 42, wherein the partitioning is periodic.

44. The apparatus of claim 42, wherein the non peer-to-peer resources are wireless wide area network (WWAN) resources.

45. The apparatus of claim 42, wherein the processing system is further configured to:
determine a partitioning of peer-to-peer data resources; and
communicate the partitioning of the peer-to-peer data resources.

46. The apparatus of claim 45, wherein the peer-to-peer scheduling resources are for scheduling a data transmission in the peer-to-peer data resources and a peer-to-peer scheduling resources bandwidth of the peer-to-peer scheduling resources is less than a peer-to-peer data resources bandwidth of the peer-to-peer data resources.

47. The apparatus of claim 46, wherein the peer-to-peer data resources bandwidth is approximately equal to the peer-to-peer scheduling resources bandwidth and a bandwidth of the non peer-to-peer resources.

48. The apparatus of claim 42, wherein the plurality of serial scheduling resource segments comprise at least three serial scheduling segments.
